(19) United States
(12) Patent Application Publication
(10) Pub. No.: US 2003/0167927 A1
(43) Pub. Date: Sep. 11, 2003

(54) Disposable filter with water trap

(75) Inventor: Anders Ostberg, Solna (SE)

Correspondence Address: SCHIFF HARDIN & WAITE, 6600 SEARS TOWER, 233 S WACKER DR, CHICAGO, IL, 60606-6473, US

(73) Assignee: Siemens Elema AB

(21) Appl. No.: 10/357,988

(22) Filed: Feb. 4, 2003

(30) Foreign Application Priority Data
Mar. 5, 2002 (SE) 0200655-9

(51) Int. Cl. B01D 46/00

(52) U.S. Cl. 96/414; 55/423; 55/428; 96/416; 96/417

(57) ABSTRACT

A disposable filter for filtering exhaled gas in a breathing apparatus has a housing with an inlet and an outlet and a filter unit disposed in the housing. To increase the efficiency of the disposable filter a water trap is integrated with the housing, with water that condenses in the filter unit being collected in the water trap.

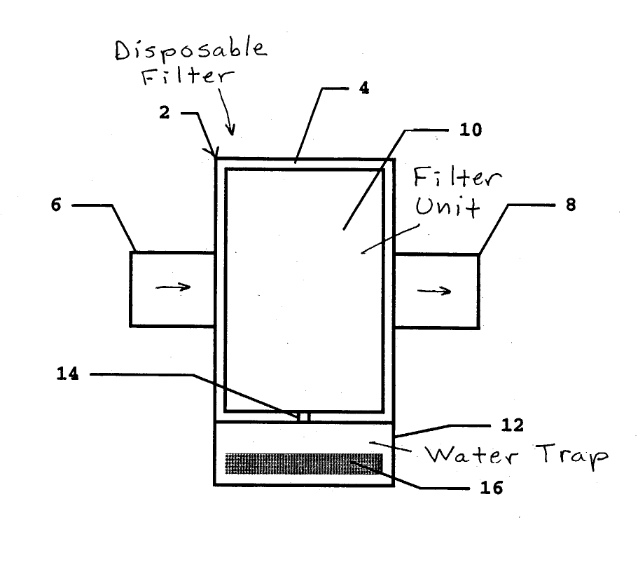

### BACKGROUND OF THE INVENTION

1. Field of the Invention

The present invention relates to a disposable filter of the type having a housing with an inlet and an outlet, and a filter unit in the housing between the inlet and the outlet.

2. Description of the Prior Art

Disposable filters, especially bacteria filters, are used in respiratory devices such as ventilators and anesthetic apparatuses to filter exhaled gas from a patient. The filter prevents the contamination of the device and the surroundings. The disposable filter is changed at regular intervals, for example once a day.

Moisture is a problem with the use of such a filter for exhaled gas. Exhaled gas is saturated with moisture that condenses in the filter. The water affects the flowthrough area and thus the effectiveness of the filter. The water also results in an increase in the pressure drop across the filter.

A known way to avoid the build-up of condensation is to supply heat to the filter. This, however, requires that energy be supplied and that some form of heating component be built in or around the filter. Such solutions are on the whole expensive and impractical to implement for disposable filters.

Another way to reduce the problem of condensation is to dehumidify the gas before it reaches the filter, or to place the filter so that water does not pool therein.

Both of these solutions, however, require the use of several other components that reduces the ability to make use of the disposable filter for all the different situations where filtration of exhaled gas is desired.

### SUMMARY OF THE INVENTION

An object of the present invention is to provide a disposable filter, which, is simple, inexpensive and practical, and thus can be used for the filtration of exhaled gas without the above-described disadvantages.

This object is achieved in accordance with the invention in a disposable filter of the type initially described wherein a water trap is integrated in the housing to collect water that condenses in the filter unit during usage.

A water trap integrated with the disposable filter results in the water that condenses in the filter being drained from the filter unit itself, so it does not affect the flowthrough area and pressure drop as long as the water trap does not become full.

The water trap may be suitably constructed using a transparent material so that the condensed water is visible.

The volume of the water trap may be adapted to the life expectancy of the disposable filter using an estimation of the amount of water that under normal conditions can be expected to condense. It is even possible to provide disposable filters respectively with water traps of different volumes.

To enable the water level in the water trap to be more easily read the water that condenses may be colored. One way to color the water that condenses is to cover the walls of the water trap with an indicator that reacts with the water and thereby colors it. Such an indicator can react to the pH of the water or to another of its properties. Indicators of this kind are known in the field of chemistry. The indicator should, of course, be safe.

Another way to color the water is by means of color ampoules, tablets or the like.

### DESCRIPTION OF THE DRAWINGS

The single FIGURE shows an embodiment of the disposable filter according to the present invention.

### DESCRIPTION OF THE PREFERRED EMBODIMENTS

An embodiment of the invention is shown in the form of a disposable filter 2. The disposable filter 2 has a housing 4 with an inlet 6 and an outlet 8 for connection of the disposable filter 2 to an expiratory part of a coupling to a ventilator or anesthetic apparatus (not shown in the figure).

The disposable filter 2 contains a filter unit 10, which filters the exhaled gas that passes through the disposable filter 2. The filter unit 10 may be a bacteria filter.

A water trap 12 is integrated with the housing 4 in order to collect the water that condenses in the filter unit 10 and the housing 4. The water is able to run into the water trap 12 via a connection 14. The connection 14 may be formed in a number of ways. It can have one or several holes, placed in different parts. It can have vents, a fine-meshed net, a water permeable filter or the like. The important thing is that water is able to pass to the water trap 12.

The simplest connection 14 is formed by a hole that is equivalent to the entire contact surface. In principle this means that the housing 4 may be designed with a bigger volume than is occupied by the filter unit 10 and this excess volume forms the water trap 12. The filter unit 10 may be, for example, centered and/or kept in position by gluing against a wall of the housing 4. The water trap 12 is shown in the figure as being an asymmetrical part of the disposable filter 2, but it may be symmetrically divided. The latter thus results in the disposable filter 2 being able to be placed in position in either of two 180°-rotated orientations.

The water trap 12 results in the filter unit 10 remaining effective during its entire expected lifetime without a decrease of the effective filter area and without a rise in the pressure drop through the disposable filter 2.

The volume of the water trap 12 may be adapted to a calculated maximum volume of condensed water during the life expectancy of the disposable filter 2.

The quantity of water becomes a measure of consumed time but, above all, the water level in the water trap provides a clear indication of the degree of use of the disposable filter 2.

To make it easier to see the water level, the condensed water can be colored as indicated by 16. This may be achieved with a color ampoule or an indicator substance placed in the water trap 12.

Although modifications and changes may be suggested by those skilled in the art, it is the intention of the inventor to embody within the patent warranted hereon all changes and modifications as reasonably and properly come within the scope of his contribution to the art.

I claim as my invention:

1. A disposable filter for filtering exhaled gas in a breathing apparatus, comprising a housing having an inlet and an outlet, a filter unit disposed in the housing between the inlet and outlet, and a water trap integrated with the housing, with water that condenses in the filter unit being collected in the water trap.

2. A disposable filter as claimed in claim 1 wherein said water trap has a transparent region wherein said water is collected.

3. A disposable filter as claimed in claim 2, comprising a coloring agent for coloring the water collected in the water trap.
